(19) United States
(12) Patent Application Publication
(10) Pub. No.: US 2013/0290395 A1
(43) Pub. Date: Oct. 31, 2013

(54) MULTIMEDIA APPLICATION RENTAL AND BILLING

(71) Applicant: Peter Vullings, Palmerston North (NZ)

(72) Inventor: Peter Vullings, Palmerston North (NZ)

(73) Assignee: EMPIRE TECHNOLOGY DEVELOPMENT LLC, Wilmington, DE (US)

(21) Appl. No.: 13/702,944

(22) PCT Filed: Apr. 26, 2012
(86) PCT No.: PCT/US12/35240

§ 371 Date: Dec. 7, 2012

(51) Int. Cl. H04L 29/08

(52) U.S. Cl. CPC H04L 67/10
USPC 709/201

(57) ABSTRACT

Technologies are generally described for systems and methods effective to provide a multimedia application rental and billing system. In an example, a host device can be provided to host a multimedia application that is remotely operated on a client device. A peer to peer connection between the host device and the client device can transfer input and output back and forth between the devices. In another example, a network service can be provided to generate a set of multimedia applications that are available to rent, filter the set based on feedback from a client device, and initiate a connection between the host device and client device when a selection of a multimedia application is received. Payment can be transferred, or a credit account can be deducted based on the multimedia application selected and the duration of the rental session.

### TECHNICAL FIELD

The subject disclosure relates generally to multimedia application rental and billing.

### BACKGROUND

As computing devices and console systems become increasingly advanced, the applications that execute on such computing devices and consoles are becoming increasingly complex. Increasingly, software or multimedia content is developed with large teams of programmers working for a year or more on a single release. The publishers of the software or multimedia content therefore price the product accordingly, and it is not uncommon to find the latest generations of computing device and console multimedia applications (e.g., games, movies, etc.) approaching the cost of the underlying hardware itself.

The large upfront cost of purchasing these multimedia applications or content can deter casual buyers who may not want to spend large amounts of money on multimedia applications that they may anticipate they will use for limited periods of time. This high-end software market is to be contrasted with applications designed for mobile devices that often sell for more nominal amounts. There, the nominal cost is not as much a barrier to entry, leading to more widespread and cost-agnostic adoption.

Several companies offer rental services where software titles can be rented for a period of time. These rental services require the physical media on which the software is stored to be either picked up at a store or mailed to the renter. Disadvantages of these rental methods are that software titles can be limited and, while the media is in transit, the renters are unable to use the software that they are renting.

### SUMMARY

Various non-limiting embodiments provide for multimedia application rental and billing. In an example embodiment, a system comprises a detection component configured to detect a request to initiate a multimedia application registered with a network device. The system also comprises a playback component configured to initiate execution of the multimedia application in response to detection of the request by the detection component and a transfer component configured to transfer output of the multimedia application to a device.

In another example embodiment, a method comprises detecting, by a system including at least one processor, a request to initiate a multimedia application registered with an online service from a device associated with the online service. The method also comprises initiating execution of the multimedia application in response to detecting the request and transferring output of the multimedia application to the device.

In another example embodiment, a system comprises a memory and at least one processor, communicatively coupled to the memory that executes computer-executable instructions to at least generate or receive a set of multimedia applications that are available to rent. The executed instructions also can filter the set of multimedia applications based on filter information received from a browser application, receive a selection of a multimedia application from the filtered set of multimedia applications from a device and negotiate a connection between a first system that hosts the multimedia application and the device.

In another example embodiment, a computer readable storage device has computer executable instructions that, in response to execution, cause a computing system to perform operations comprising generating a set of multimedia applications to rent and filtering the set of multimedia applications in response to receiving filter information from a browser application. The operations can also comprise detecting a selection of a multimedia application from the set of multimedia applications from a client device and connecting the client device with a host system that executes the multimedia application.

In another example embodiment, a system comprises a selection component configured to send a request to rent a multimedia application hosted by a host system in response to selection of the multimedia application from a set of multimedia applications available to rent on display with an amount of credit available for rental of the set of multimedia applications. The system can also comprise a connection component configured to initiate a connection with the host system, wherein the connection component sends input to the host system and receives video and audio output over the connection.

In another example embodiment, a system comprises means for sending a request to rent a multimedia application based on a selection of the multimedia application from a set of multimedia applications available to rent. The system can also include a means for connecting with a host system that executes the multimedia application, sending multimedia application input to the host system and receiving video and audio output from the multimedia application.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

Various non-limiting embodiments are further described with reference to the accompanying drawings in which:

FIG. 1 is a block diagram illustrating an example, non-limiting embodiment of a system for renting multimedia applications;

FIG. 2 is a block diagram illustrating an example, non-limiting embodiment of a system for hosting a multimedia application;

FIG. 3 is a block diagram illustrating an example, non-limiting embodiment of a system for registering multimedia applications available for rent with an online service;

FIG. 4 illustrates a flow diagram of an example, non-limiting embodiment of a method for transferring output of a hosted multimedia application to a device;

FIG. 5 is a block diagram illustrating an example, non-limiting embodiment of a system for linking multimedia application renters and host systems;

FIG. 6 is a block diagram illustrating an example, non-limiting embodiment of a system for billing a multimedia application renter;

FIG. 7 illustrates a flow diagram of an example, non-limiting embodiment of a method for linking multimedia application renters and host systems;

FIG. 8 is a block diagram illustrating an example, non-limiting embodiment of a system for renting and operating a multimedia application;

FIG. 9 illustrates a flow diagram of an example, non-limiting embodiment of sending a request to rent a multimedia application;

FIG. 10 illustrates a flow diagram of an example, non-limiting embodiment of connecting with a host system that executes the multimedia application;

FIG. 11 illustrates a flow diagram of an example, non-limiting embodiment of monitoring a quality of service level of a connection with the host system;

FIG. 12 is a block diagram illustrating an example computing device that is arranged for at least some of the embodiments of the subject disclosure; and

FIG. 13 is a block diagram illustrating an example networking environment that can be employed in accordance with the claimed subject matter.

### DETAILED DESCRIPTION

### Overview

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, a multimedia application rental and billing system is provided that allows rental of multimedia applications installed on consumer's computing devices, consoles game systems, and mobile devices in exchange for financial or other forms of compensation. The multimedia applications can be executed by a host system and the application's output can be delivered via a network connection to a client computer and/or device. The connection also allows feedback to be transferred from the client device to the host system which incorporates the feedback into the operation of the multimedia application. The multimedia application can therefore be running remotely on a machine owned and operated by one person, and played or utilized on another machine owned and operated by somebody else.

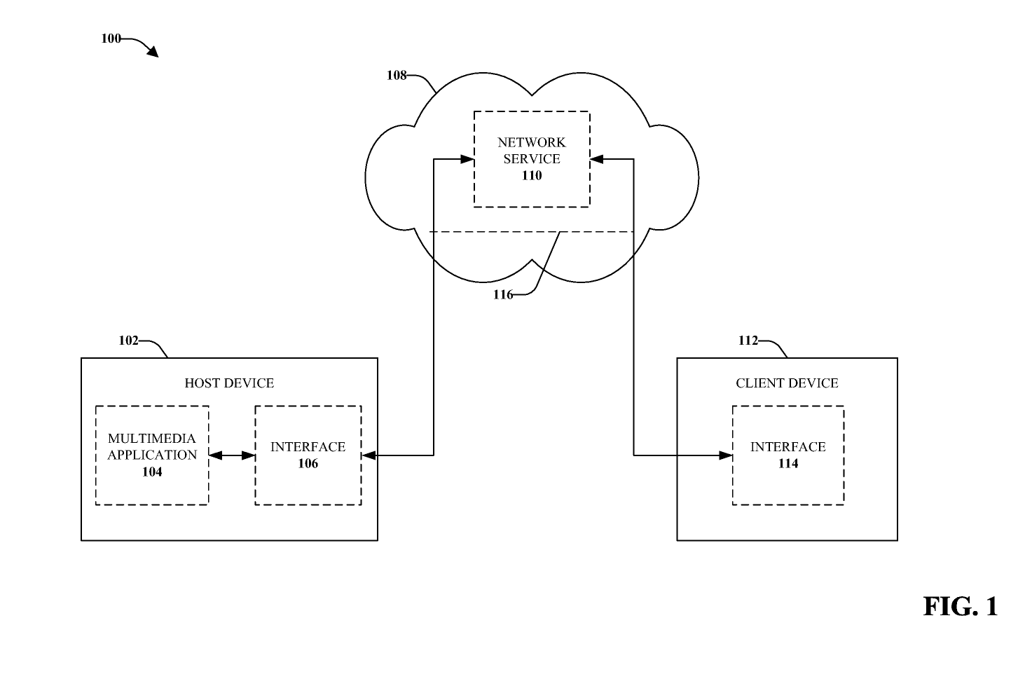

By way of example, FIG. 1 illustrates a block diagram of an example, non-limiting embodiment of a system for renting multimedia applications. As shown in FIG. 1, a system 100 includes a host device 102, an online/network service 110, and a client device 112. Host device 102 can include a multimedia application 104 that is available to rent and an interface 106 that communicates with the network service 110 and the client device 112. The network service 110 can be a cloud service and accessed via the internet 108. The client device 112 can include an interface 114 that connects the client device 112 to the network service 110 and the interface 106.

The host device 102 can include one or more multimedia applications that are available to rent (although for purposes of simplicity, only one multimedia application, 104, is shown in FIG. 1). Software installed on the host device 102 (e.g., the interface 106), can be used to provide authentication information to the network service 110, the authentication information associating the host device 102 with a seller account registered with the network service 110. The interface 106 can also register the multimedia application 104 with the network service 110, indicating that is available to rent and providing information about the multimedia application 104, such as minimum computer requirements and network specifications. If the host device 102's connection to the internet 108 is below the minimum network specifications, the network service 110 can decline to list the multimedia application 104 as available to rent.

The network service 110 can list available multimedia applications from a number of host devices (although for simplicity, FIG. 1 shows only one host device). The interface 114 on the client device 112 can facilitate browsing through multimedia applications available to rent via the network service 110. The network service 110 can include details about the multimedia applications, such as cost of rental, for how long the multimedia applications are available, approximate location of the host devices hosting the multimedia applications, connection speed of the connections between the host devices and the network service 110, as well as the connection speed and latency of connection 116 and other pertinent information.

When the network service 110 receives a selection of a multimedia application to rent (in this case, multimedia application 104), the network service 110 can facilitate a connection 116 between interface 106 and interface 114 on the host device 102 and client device 112 respectively. The connection 116 can be a peer to peer (“P2P”) connection via the internet 108. When the connection 116 is established, the host device 102 can initialize execution of the multimedia application 104 and the host device 102 can transmit the output (e.g. audio, video, and etc.) of the multimedia application 104 via the interfaces 106 and 114. The connection 116 can be two way, allowing output of the multimedia application 104 to be transmitted to the client device 112 and input and/or feedback to be transmitted from the client device 112 to the host device 102. The multimedia application can thus be physically operated by the host device 102, and client device 112 can virtually operate the multimedia application 104 remotely.

The network service 110 can also facilitate payment from a purchaser to a seller. The seller, associated with the host device 102, can have an account on the network service 110 that receives funds when the multimedia application 104 is rented by a purchaser, associated with the client device 112. The network service 110 can receive payment directly from a purchaser, or debit an account maintained by the purchaser on the network service 110. The network service 110 can charge a percentage of the rental fee as a royalty for facilitating the rental. The network service 110 can also charge a fee for being a seller, a fee per game rented, a fee for being a purchaser and/or a subscription to the network service 110. A user of the network service 110 can be both a purchaser and a seller, and can maintain one account that is debited or credited when renting or hosting multimedia applications. By extension, host device 102 and client device 112 can switch roles, and become a client device and host device respectively, depending on whether the user is hosting or renting a multimedia application.

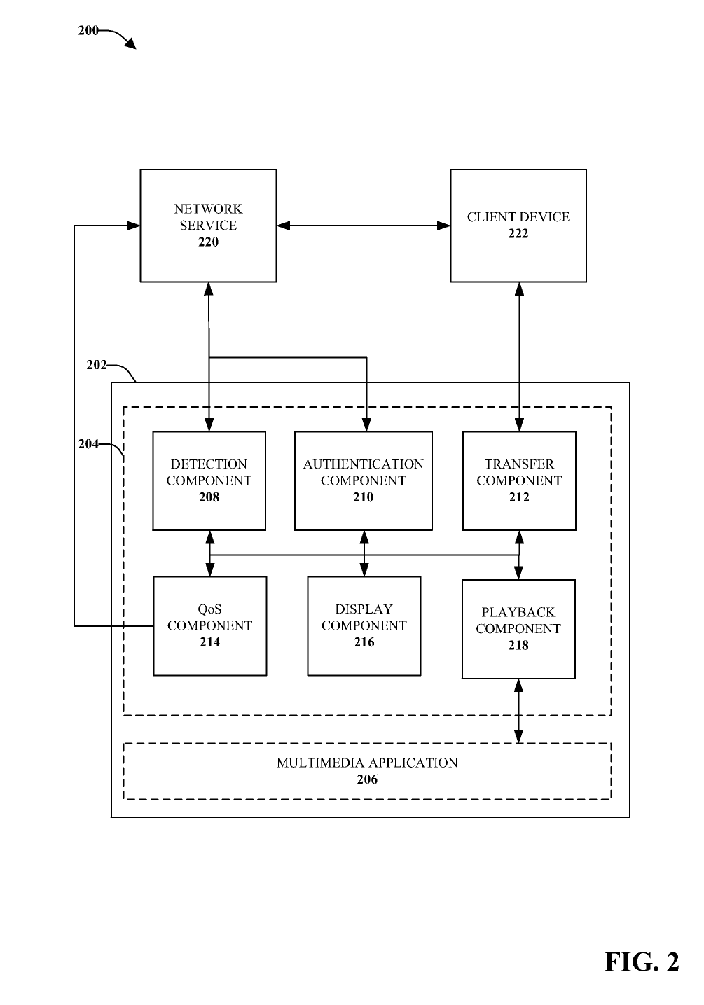

Turning now to FIG. 2, a block diagram illustrating an example, non-limiting embodiment of a system for hosting a multimedia application is shown. As shown in FIG. 2, a system 200 includes a host device 202 with an interface 204 and at least one multimedia application 206. Provided in the interface are a detection component 208 configured to detect a request to initiate the multimedia application 206 registered with a network service 220 and a playback component 218 that is configured to initiate execution of the multimedia application 206 in response to detection of the request by the detection component 208. A transfer component 212 is also provided and is configured to transfer output of the multimedia application 206 to a client device 222. Also provided is an authentication component 210 that is configured to provide identification information to the network service 220, a quality of service (“QoS”) component 214 configured to transmit quality of service information to the network service 220, and a display component 216 configured to display information about the multimedia application 206.

The detection component 208 can detect a request to rent the multimedia application 206 that can be issued by the network service 220. In some embodiments, the selection of the multimedia application 206 can initiate from the client device 222, but the network service 220 issues the request to the host device 202. In other embodiments, the client device 222 can issue the request directly to the host device 202. When the request to rent the multimedia application 206 is detected by the detection component 208, the playback component 218 can initiate execution of the multimedia application 206 by the host device 202.

The multimedia application 206 can run on the host device 202 as normal, but transfer component 212 can redirect output of the multimedia application 206 from the host device 202's attached output devices (e.g., sound card and video card and/or speakers and monitor). The transfer component 212 can transfer the output to client device 222 over a P2P connection that can be secured or unsecured. The transfer component 212 can also receive feedback and/or input from the client device 222 and forward the feedback to the playback component 218 which is input into the multimedia application 206. In another embodiment, the transfer component 212 can transfer the output and input to and from the client device 222 via the network service 220.

The authentication component 210 can be configured to provide identification information to the network service 220 and the identification information can be used to authenticate the host device 202 with the network service 220. The identification information can include login information associated with the seller, and can also include location information. The location information can for example be a mailing address associated with the seller, or can be from an IP address that is associated with the host device 202. The login information can be a username and password associated with the seller's account at the network service 220, or it could be a unique ID associated with the host device 202. The login information can be stored on the host device 202 and can be used to automatically authenticate the host device 202 with the network service 220.

The display component 216 can be configured to display information about the multimedia application 206. The information can be displayed on the host device 202, such that it is viewable by the seller. In other embodiments, some portions of the information can also be displayed via the network service 220. The displayed information can include live game activity information, game history information, and credit information. The live game activity information can be a copy of the video/audio feed that is being transferred to the client device 222. The seller can thus view in real-time the progress of the game or multimedia application 206. The live game activity information can also include real-time statistics about the multimedia application 206, like whether a rental session is in progress, and the memory, network, and CPU statistics. The game history information can include historical statistics about the multimedia application 206. Credit information displayed by the display component 216 can show the level and rate of accumulation of credit available to the seller as the multimedia application 206 is rented.

The QoS component 214 can be configured to transmit QoS information to the network service 220. QoS information can include CPU, memory, and network statistics that can be used to filter the list of available multimedia applications to rent on the network service 220 and can also be used to monitor the connection between the host device 202 and the client device 222.

In other embodiments, the QoS component 214 can also be configured to block processes that are unrelated to the execution and transfer of the multimedia application 206 on the host device 202 during a rental session. Monitoring performance statistics and the connection between the host device 202 and client device 222 can allow the QoS component 214 to selectively disable unrelated applications and processes in order to ensure that the multimedia application 206 and the interface 204 receive a predetermined minimum level of system resources. The predetermined minimum level of system resources can be dependent on the multimedia application 206. In some embodiments, the QoS component 214 can be configured to lower the quality of the output in order for the quality of service levels to remain at acceptable levels. The QoS component 214 can lower a frame rate and/or resolution of the video, and lower a bitrate of the audio.

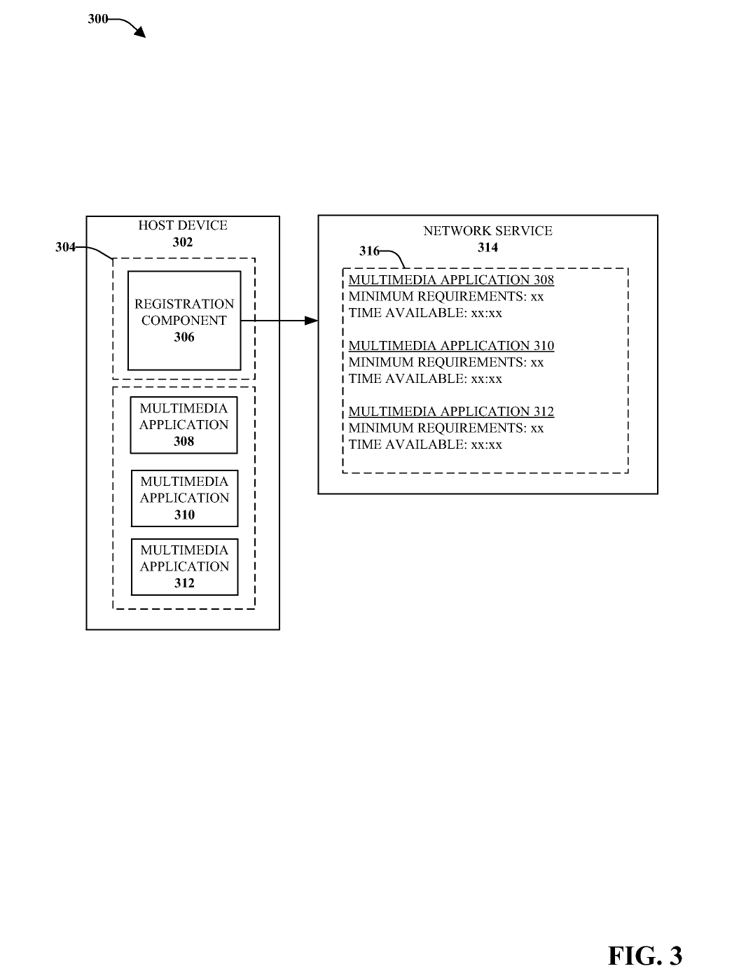

Turning now to FIG. 3, a block diagram illustrating an example, non-limiting embodiment of a system for registering multimedia applications available for rent with an online service is shown. As shown in FIG. 3, a system 300 can include a host device 302 with an interface 304 that includes a registration component 306. The host device 302 can also have installed a variety of multimedia applications 308, 310, and 312. The system 300 can also include a network service 314 that includes a database 316 of multimedia applications available to rent.

The registration component 306 can be configured to register multimedia applications (e.g., 308, 310, and 312) with the network service 314. The registration component 306 can also transmit an availability time of the multimedia applications and information about minimum system requirements for each of the multimedia applications. The availability time can be the time that the seller makes the multimedia applications available for rent. The availability time can be in the form of a countdown (e.g., the multimedia application will be available for a certain number of hours or days after registration). The availability time can also include scheduled availabilities at discrete times or on a recurring basis.

The information about minimum system requirements can be displayed alongside the title information to inform potential renters about general characteristics of the multimedia applications. The information can also be used by the network service 314 to determine minimum QoS requirements. The database 316 can thus be filtered based on CPU, memory, and network statistics and the client device. For instance, a client device that has QoS levels beneath the minimum QoS requirements of a particular multimedia application would be unable to rent that multimedia application. Client devices that are mobile devices may also be unsuitable for some multimedia applications, so the database 316 can be filtered based on the type of client device and its characteristics.

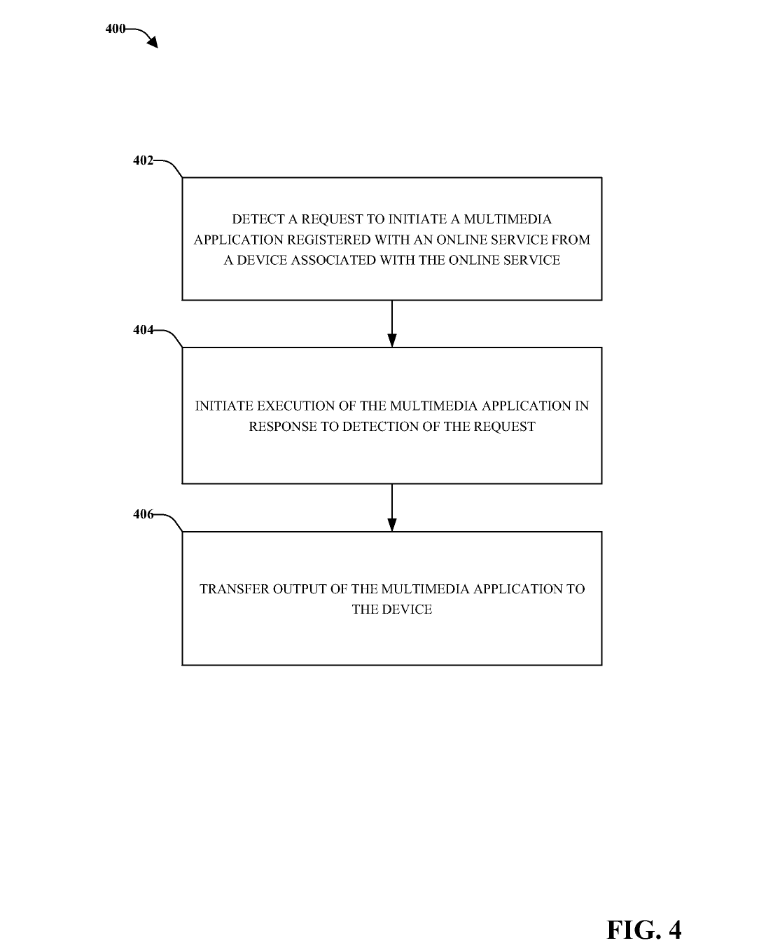

FIG. 4 illustrates processes in connection with the aforementioned systems. The processes in FIG. 4 can be implemented for example by systems 100, 200, or 300 illustrated in FIG. 1, FIG. 2, and FIG. 3 respectively.

FIG. 4 illustrates a flow diagram of an example, non-limiting embodiment of a method 400 for transferring output of a hosted multimedia application to a device. Example methods may include one or more operations, functions, or actions as illustrated by one or more of blocks 402, 404, and/or 406. At 402, a request to initiate a multimedia application registered with an online service is detected from a device associated with the online service. The request can originate with the device and can be delivered via the online service. The request can be made in response to a selection of a multimedia application to rent by the device. Detecting the request can also initiate a P2P connection between a host system and the device. The request can contain information that enables the host system to connect to the device [either directly or indirectly via the network service]. Block 402 may be followed by block 404.

At 404, execution of the multimedia application is initiated in response to detection of the request. In some embodiments, when the connection is made, the host system can start executing the multimedia application that is installed on the host system. Block 404 may be followed by block 406.

At 406, output of the multimedia application is transferred to the device. While the multimedia application is running on the host system, it can be operated remotely on the device via the connection. The connection can facilitate the transfer of audio and graphical output from the multimedia application on the host system to the device. In return, the connection can transfer feedback and input from the device to the host system. The feedback and input can be used by the host system to feed into the multimedia application, thus allowing the device to remotely control the multimedia application.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

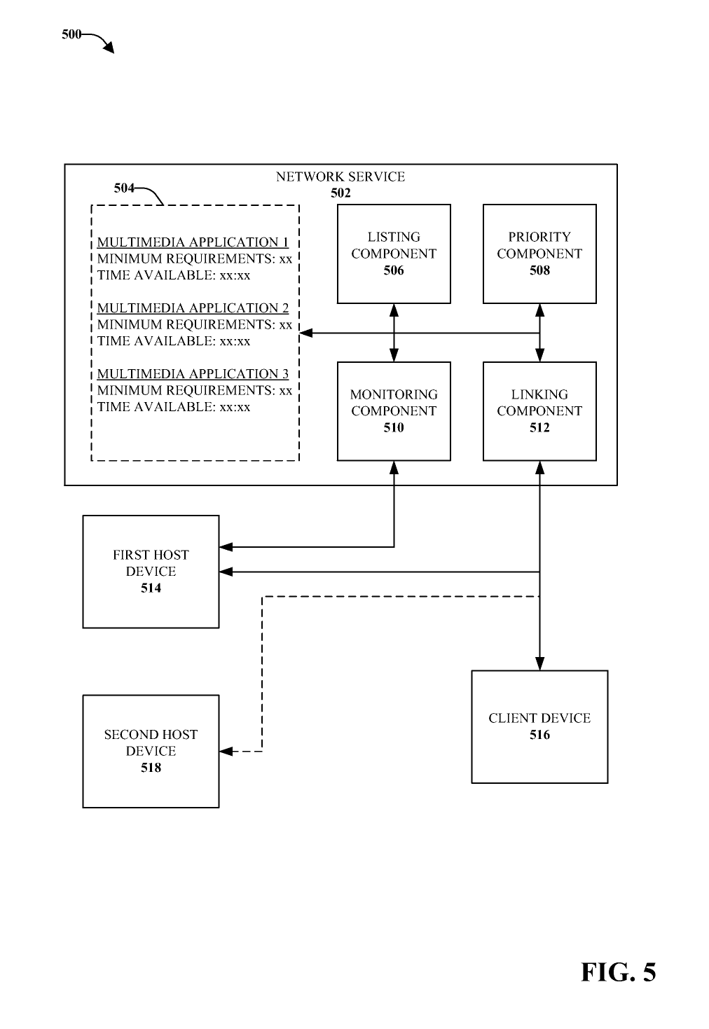

FIG. 5 is a block diagram illustrating an example, non-limiting embodiment of a system for linking multimedia application renters and host systems. As shown in FIG. 5, a system 500 includes a network service 502 that facilitates a connection between a client device 516 and a first host device 514 and a second host device 518.

The network service 502 can include a listing component 506 that generates or receives a set of multimedia applications 504 that are available to rent. The listing component 506 can also filter the set of multimedia applications 504 in response to filter information received from a browser. The network service 502 can receive a selection, from the client device 516, of a multimedia application from among the filtered set of multimedia applications 504. A linking component 512, based on the selection, can negotiate a connection between the first host device 514 and the client device 516.

The listing component 506 can receive registration information about the multimedia applications from the host devices. The registration information can also include location information, time of availability information, and system requirements information. The listing component 506 can add another multimedia application to the set of multimedia applications 504 in response to receiving registration information from the first host device 514 for the new multimedia application.

The listing component 506 can also receive information associated with the client device, such as age of the purchaser, location, and client device computing capabilities. The listing component 506 can then filter the set of multimedia applications 504 based on the information from the host devices and the client devices. For instance, listing component 506 can limit the games available to rent to the purchaser based on laws limiting content and copyright. In one embodiment, if the purchaser is a minor, listing component 506 can filter the set of multimedia applications 504 such that only age-appropriate titles are available. Similarly, listing component 506 can limit titles based on copyright laws. Some multimedia applications may not be licensed in some regions of the world, and listing component 506 can filter the set of multimedia applications 504 based on the location information of the client device 516.

A monitoring component 510 can monitor quality of service levels of the first host device 514. The quality of service levels can include latency, bandwidth, connection speed, and other system statistics. If the quality of service levels of the first host device 514 fail to meet a predetermined level, listing component 506 can filter the set of multimedia applications 504 such that multimedia applications associated with the first host device 514 are not available to rent.

The listing component 506 can receive filter information from a browser. The browser can be built into an interface on the client device 516, or can come from a web browser on another computing device, console, or mobile device. A purchaser can filter and search for multimedia applications from one system, and then remotely operate the selected multimedia application from a disparate system.

Upon receiving a selection of a multimedia application, linking component 512 can negotiate a connection between the first host device 514 that hosts the selected multimedia application and the client device 516. In one embodiment, the linking component 512 can negotiate the connection by sending connection information to both the client device 516 and the first host device 514 allowing the devices to set up a P2P connection. In another embodiment, both the client device 516 and the first host device 514 can link to the linking component 512, and the network service 502 hosts the connection.

When the connection is established, monitoring component 510 can continue to monitor quality of service levels of the first host device 514. In response to the quality of service levels of the first host device 514 falling below a predetermined level, the linking component 512 can negotiate a connection between the client device 516 and a second host device 518. In some embodiments, the linking component 512 can automatically negotiate a new connection and in other embodiments, the linking component 512 can send a request to the client device 516 for a change in host device. Linking component 512 can then negotiate a new connection in response to the client device 516 accepting the request.

A priority component 508 can be provided to adjust a priority ranking of multimedia applications in the set of multimedia applications 504 that are associated with seller identification data in response to an analysis of information associated with the seller identification data. The priority component 508 can also adjust a priority ranking of multimedia applications in the set of multimedia applications 504 in response to receiving feedback from the client device 516. The listing component 506 can filter the set of multimedia applications 504 based on the priority ranking.

The seller identification data can include rental history, system statistics and elected priority levels. Priority component 508 can analyze the rental history, and adjust the priority level based on the rental history. If a seller is in a queue to rent a multimedia application, the priority ranking can be adjusted by position in the queue. The priority ranking can also be adjusted based on host device system statistics. Faster computing systems and higher bandwidth connections can receive priority over slower host devices. Sellers can also elect to adjust their priority rankings. For instance, a seller can change their account on the network service 502 so that the network service 502 retains a higher royalty percentage. The priority level of the host device(s) associated with the seller account can thus be increased so that client devices rent from those host devices more frequently.

The priority component 508 can also adjust a priority ranking of multimedia applications in the set of multimedia applications 504 in response to receiving feedback from the client device 516 or a purchaser associated with the client device. The purchaser and/or client device can provide a feedback ranking of the rental experience, and the priority ranking of the multimedia application, or host device associated with the multimedia application can be adjusted based on the feedback ranking. The feedback rankings can be based on the quality of the connection, smoothness of remote operability, and also can be based on the content of the multimedia application.

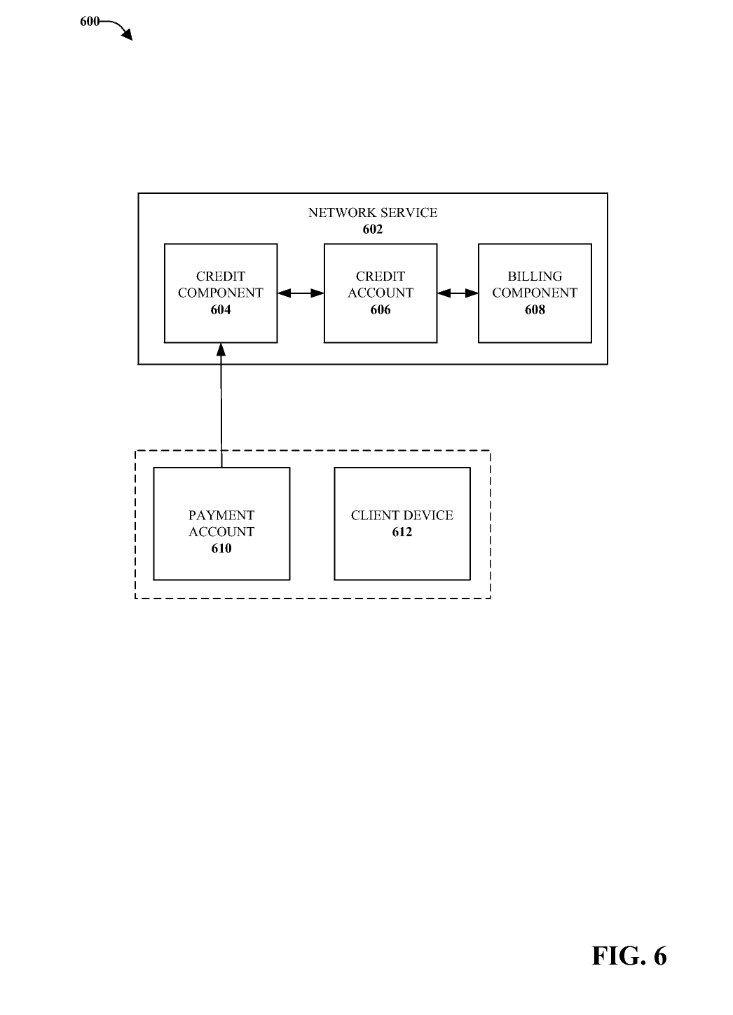

Turning now to FIG. 6, a block diagram illustrating an example, non-limiting embodiment of a system for billing a multimedia application renter is shown. As shown in FIG. 6, a system 600 includes a network service 602 that has a credit component 604 that receives payment from a payment account 610 associated with a client device 612. The credit component 604 also maintains a credit account 606 in response to reception of the payment and a billing component 608 deducts credit from the credit account 606 in response to negotiating a connection between a host device and the client device 612. The credit deducted from the credit account 606 by the billing component 608 can be a function of the multimedia application that is rented and the duration of time that the multimedia application is executed. The credit deducted from the credit account 606 can also be based on a subscription, or a fixed fee.

The payment account 610 can be a bank account, credit card account, a virtual currency account, and/or other payment accounts belonging to a purchaser associated with the client device 612. The payment can be made or initiated by the client device 612, or it can be initiated by the credit component 604 billing the payment account. In some embodiments, the credit component 604 can be configured to maintain a predetermined level of credit in the credit account 606, and whenever the balance falls below a certain level, credit component 604 can bill the payment account 610 to replenish the credit account. Billing component 608 can also directly bill the payment account 610 in case there is insufficient credit in the credit account 606.

The amount of credit deducted, or payment billed by the billing component 608 can be based on the multimedia application that is rented. Some titles can include a one-time rental fee or a fee based on an amount of time the multimedia application is rented. Billing component 608 can deduct credit or bill the payment account 610 on a scheduled or recurring basis, and can be adjusted based on the frequency of multimedia application rental sessions.

In some embodiments, the billing component 608 can delay billing the credit account 606 until after a predetermined duration of time has passed. This delay can allow a purchaser to remotely operate the multimedia application for a period of time before incurring a charge in order to ensure that the network speed and quality of connection are acceptable. If they are not acceptable, the client device can disconnect the connection, and the credit account 606 will not be billed.

In an embodiment, a proportion of any payment can be paid to the network service 602 as a royalty. The royalty could be a pro-rata proportion of the payment, or it could be a fixed fee. In another embodiment, the royalty payment, or a portion of the royalty payment, can be made to an account associated with a third party. The third party could in some situations be a publisher of the multimedia application who holds the copyright to the multimedia application.

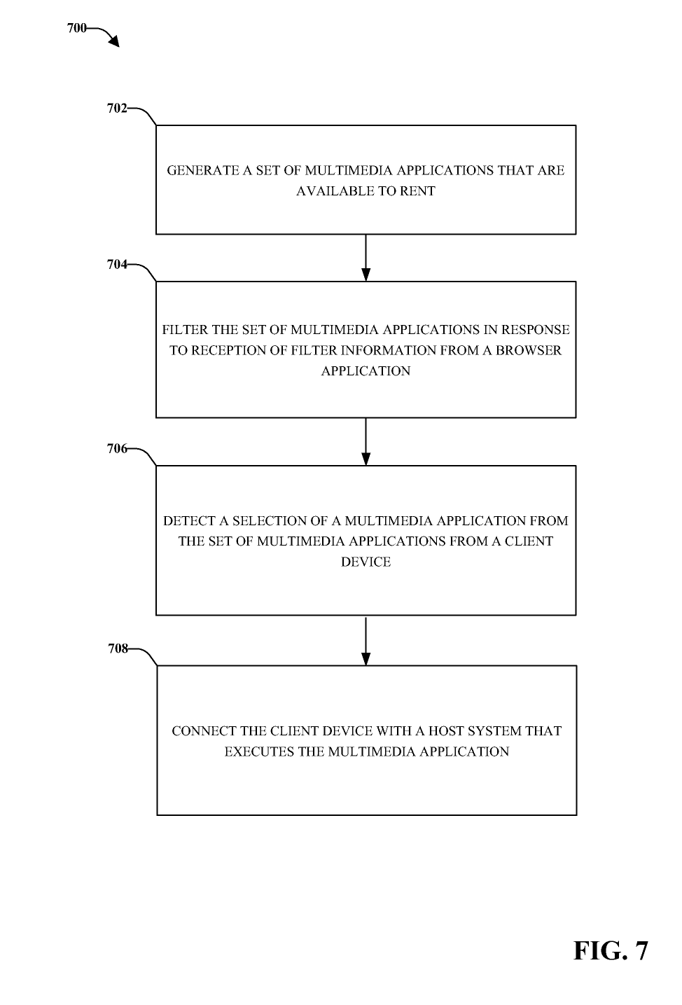

FIG. 7 illustrates a flow diagram of an example, non-limiting embodiment of a method 700 for linking multimedia application renters and host systems. The processes in FIG. 7 can be implemented for example by systems 500 or 600 illustrated in FIG. 5 and FIG. 6 respectively. Example methods may include one or more operations, functions or actions as illustrated by one or more of blocks 702, 704, 706, and/or 708. Additionally, it should be appreciated that the methods disclosed in this specification are capable of being stored as computer-executable instructions on a non-transitory computer readable medium that in response to execution, cause a system including at least one processor to perform operations in accordance with the methods.

At 702, a set of multimedia applications that are available to rent is generated. The set can include all of the multimedia applications that are available to rent or subset of the entire list of multimedia applications. The multimedia applications can be registered with a network service and associated with host devices that are currently logged in at the network service. Block 702 may be followed by block 704.

At 704, the set of multimedia applications is filtered in response to reception of filter information from a browser application. The filter information can come from browser applications associated with the host devices and the client devices. The filter information associated with the client device can include multimedia application search queries, preferences, location of the client device as well as demographic information about a purchaser associated with the client device.

The set of multimedia applications can be filtered based on laws limiting content and copyright. If the purchaser is a minor, the set of multimedia applications can be filtered such that only age-appropriate titles are available. Similarly, titles can be limited based on copyright laws. Some multimedia applications may not be licensed in some regions of the world, and the set of multimedia applications can be filtered based on the location information of the client device.

The browser application can be built into an interface on the client device or can come from a web browser on another computing device, console, or mobile device. A purchaser can filter and search for multimedia applications on one system, and then remotely operate the selected multimedia application from a disparate system. Block 704 may be followed by block 706.

At 706, selection of a multimedia application from the set of multimedia applications is detected from a client device. In response to detection of the selection, block 706 may be followed by block 708 where the client device is connected with a host system that executes the multimedia application. The connection can be hosted by the network service in some embodiments, and in other embodiments, the network service can negotiating the connection by providing connection information to the host device and the client device. The host device and the client device can then initiate a P2P connection.

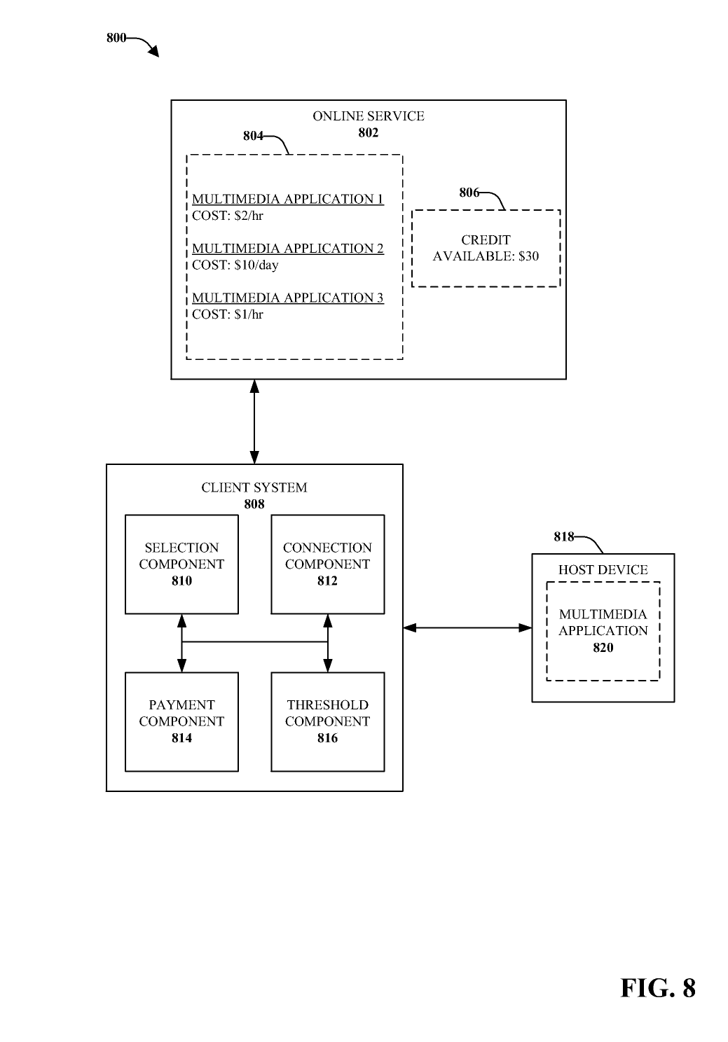

FIG. 8 is a block diagram illustrating an example, non-limiting embodiment of a system for renting and operating a multimedia application. As shown in FIG. 8, a system 800 includes an online service 802 that negotiates a connection between a client system 808 and a host device 818 in order for the client system to remotely operate a multimedia application 820 executed on the host device 818. Provided also in system 800 is a selection component 810 configured to send a request to rent the multimedia application 820 hosted by host device 818 in response to a selection of the multimedia application 820 from a set of multimedia applications 804 available to rent on display with an amount of credit available 806 Provided also is a connection component 812 configured to initiate a connection with the host system, wherein the connection component 812 sends input to the host system and receives video and audio output from the multimedia application 820 over the connection.

The selection component 810 can select the multimedia application 820 based at least in part on the cost of the multimedia application 820. If the multimedia application 820 is hosted by more than one host device, the selection component 810 can be configured to automatically select the cheaper multimedia application to rent. The selection can also be based at least in part on the amount of credit available 806. The selection component 810 can select multimedia applications that a credit account on the online service 802 has sufficient credit for.

Once a selection to rent multimedia application 820 has been made, connection component 812 can be configured to initiate the connection. In some embodiments, the connection can be via the online service 802, and in other embodiments the connection can be a P2P connection directly between the client system 808 and the host device 818. The online service 802 can provide the connection information necessary to initiate the connection.

Also provided in client system 808 is a threshold component that can be configured to monitor a quality of service level of the connection and cancel the connection in response to the quality of service level falling below a predetermined value. In some embodiments, in response to the quality of service level falling below the predetermined value, threshold component 816 can send a request to the host device 818 to degrade or lower the quality of the output (e.g., decrease frame rate, decrease resolution, lower audio bitrate, etc.) in order for the quality of service level to remain above the predetermined value.

The predetermined value can be based at least in part on the multimedia application 820 that is selected. Some multimedia applications are more resource intensive than others, and so the predetermined value can be relatively higher than other applications. In some embodiments, in response to the quality of service level falling below the predetermined value, the threshold component 816 can send a request to the online service 802 to switch to a new host device running the same multimedia application 820.

Provided also is a payment component 814 that can be configured to send payment to the online service 802 to increase the amount of credit available. The payment component 814 can send payment to keep the credit balance at a predetermined level. The payment component 814 can also send payment to the online service 802 in response to receiving a billing statement, or a request for payment from the online service 802. The payment component 814 can send funds directly, or can send instructions to an account associated with the purchaser to send funds to the online service 802.

After a rental session is complete, the client system 808 can also provide functionality to allow the purchaser to rate the multimedia application 820 or provide feedback on the connection with the host device 818. The feedback and ratings can be sent to the online service 802 to assist with priority rankings of the set of multimedia applications 804.

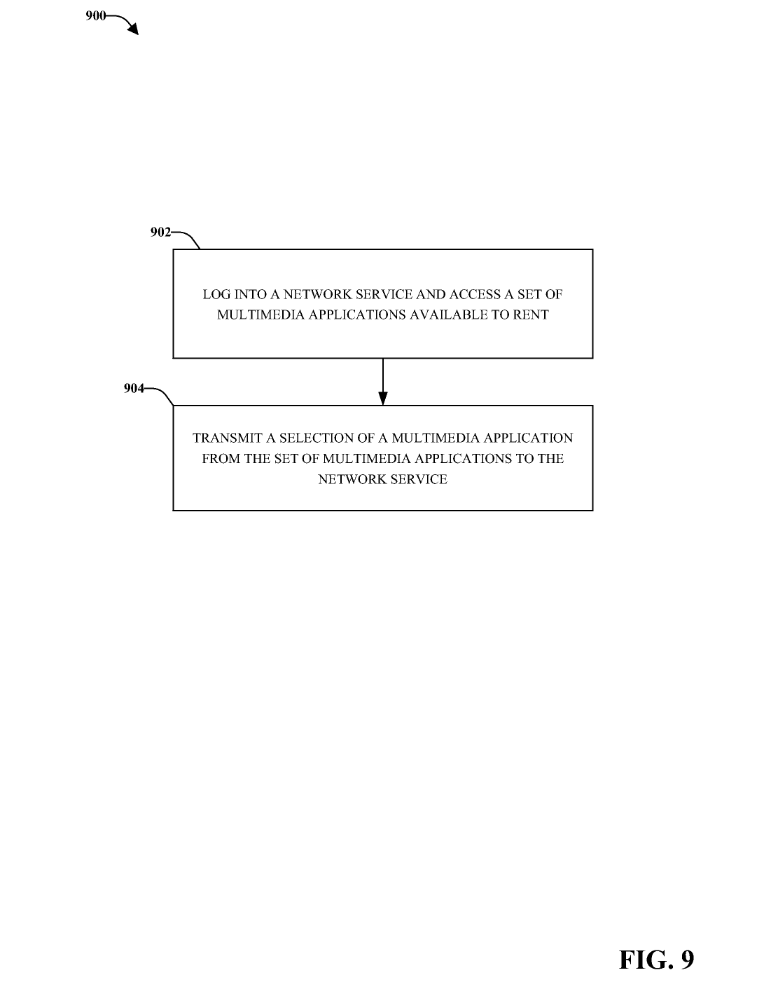

FIG. 9 illustrates a flow diagram of an example, non-limiting embodiment of sending 900 a request to rent a multimedia application. Example methods may include one or more operations, functions, or actions as illustrated by one or more of blocks 902 and/or 904. At 902, a set of multimedia applications available to rent are accessed after a network service is logged into. The logging into the network service can include providing login information that associates a client device with an account on the network service. Once the client device is logged in, a browser application on the client device can browse through a database of multimedia applications that are available to rent. Through the browser application, filter information can be transmitted to the network service and the list of multimedia applications can be narrowed. Block 902 may be followed by block 904.

At 904, a selection of a multimedia applications from among the set of multimedia applications is transmitted to the network service. In some embodiments, the selection can be transmitted through the browser application on the client device. In other embodiments, the selection can be transmitted through a browser application on a different device than the client device.

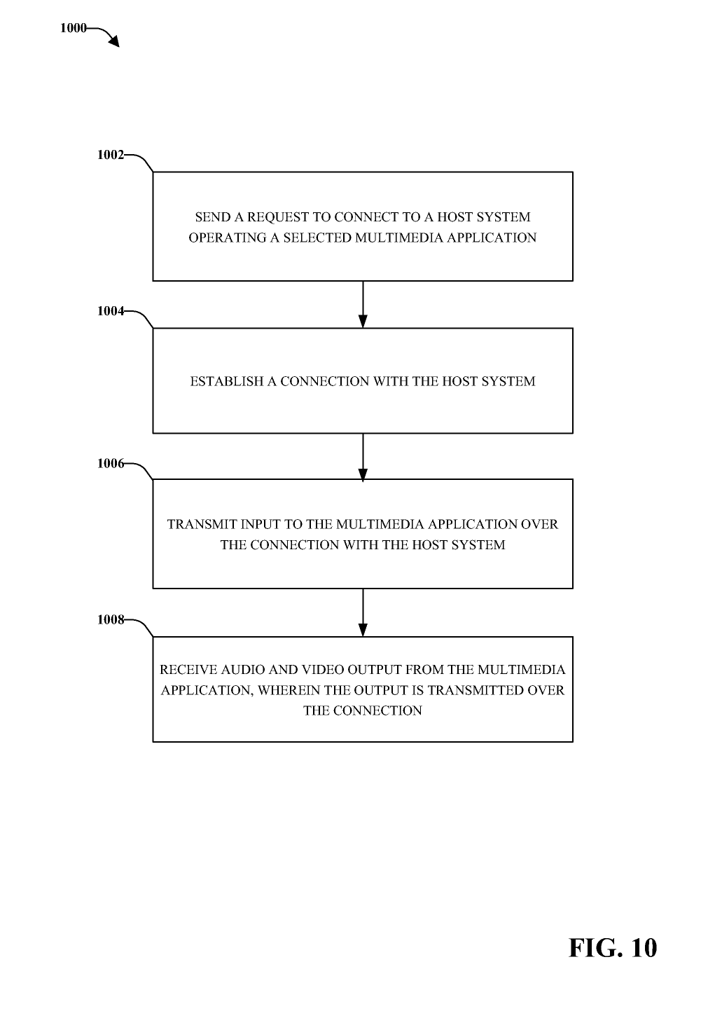

FIG. 10 illustrates a flow diagram of an example, non-limiting embodiment of connecting 1000 with a host system that executes a multimedia application. Example methods may include one or more operations, functions, or actions as illustrated by one or more of blocks 1002, 1004, 1006, and/or 1008. At 1002, a request to connect to a host system operating a selected multimedia application is sent. The request can be sent to the host system via the network service. The request can originate from the client device or the network service. When the request is accepted by the host system, at 1004 a connection between the host system and the client device is established. The connection can be a P2P connection that is facilitated by the network service, or the connection can be via the network service. Block 1004 may be followed by block 1006.

At 1006, input to the multimedia application is transmitted over the connection with the host system. While the multimedia is being executed by the host system, it is remotely operated by the client device, and the input can be used by the host system to operate the multimedia application. The input can include physical input such as from a keyboard, mouse, touch screen, stylus, joystick, game pad, and/or directional pad. The input can also include audio and visual input such as voice commands and gestures recorded by a microphone and camera. Block 1006 may be followed by block 1008. At 1008, audio and video output from the multimedia application can be received over the connection.

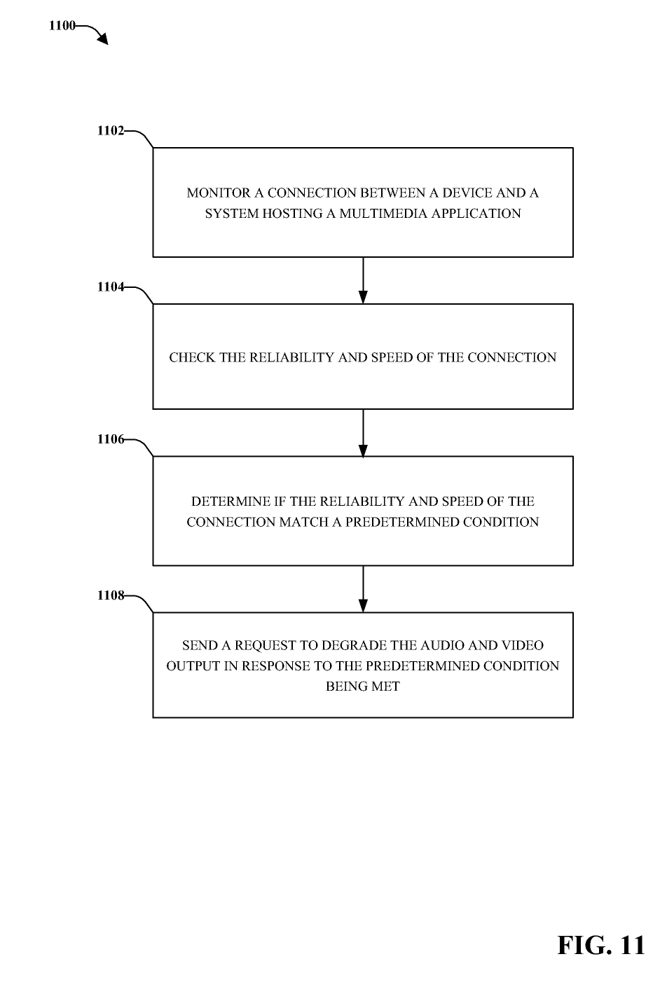

FIG. 11 illustrates a flow diagram of an example, non-limiting embodiment of monitoring 1100 a quality of service level of a connection with the host system. The connection can be canceled, or the output quality of the host device can be degraded, in response to the quality of service level satisfying a predetermined condition. Example methods may include one or more operations, functions, or actions as illustrated by one or more of blocks 1102, 1104, 1106, and/or 1108.

At 1102, a connection between a device and a system hosting a multimedia application is monitored. Next, at 1104, the device can monitor the incoming and outgoing packets from the connection to check the reliability and speed of the connection. The device can also monitor the content of the connection, frame rate of the video, clarity of the audio and so forth. Block 1104 may be followed by block 1106

At 1106, it can be determined whether the reliability and speed of the connection match a predetermined condition. The predetermined condition can be a minimum level that the connection must surpass. The minimum level can be based on the multimedia application that is being rented. Some multimedia applications that are graphic or resource intensive may have a minimum level that is higher than a simple multimedia application. The frame rate of the video outputted can also be monitored, and it can be determined if that falls below a minimum level. Block 1106 may be followed by block 1108.

At 1108, in response to the predetermined condition being met, the connection can be cancelled. In some embodiments, the device can unilaterally break off the connection thus ending the rental session. In other embodiments, the device can send a request to the network service to terminate the connection and establish a new connection with a different host system. In some embodiments, a request can be sent from the client device to the host device to degrade the quality of the audio and video output if the predetermined condition is met. The lower resolution, bitrate, and/or frame rate can ensure that the quality of service level remains above the predetermined condition.

### Example Computing Environment

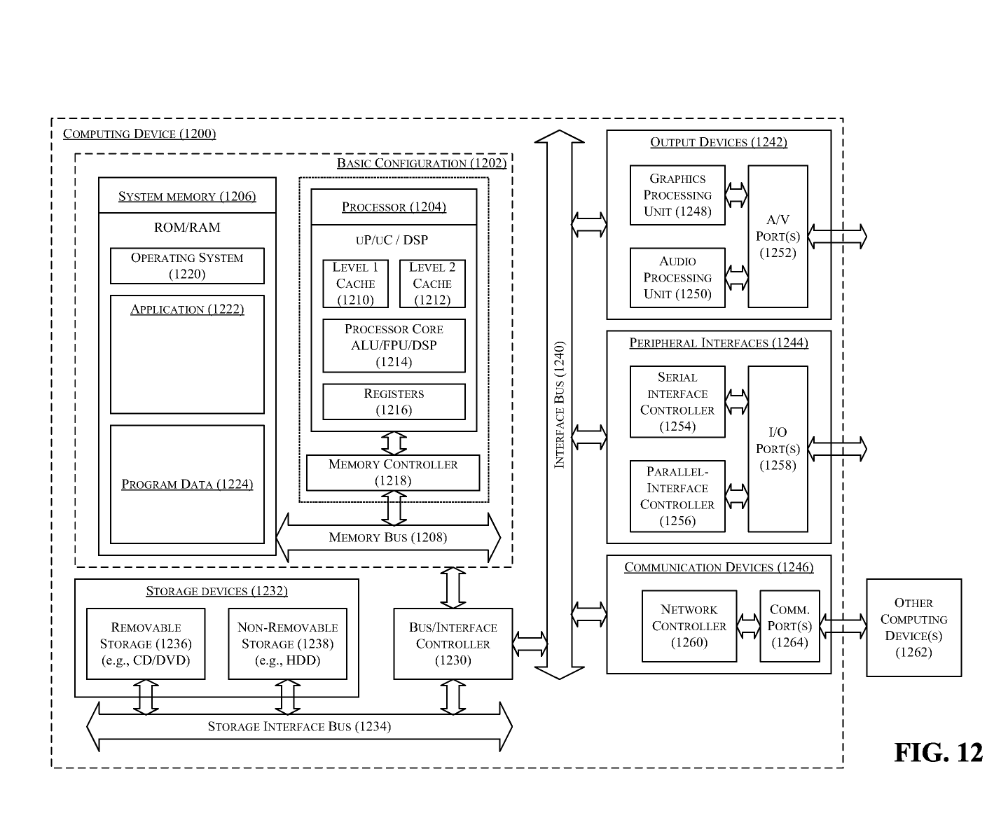

FIG. 12 is a block diagram illustrating an example computing device that is arranged for at least some of the embodiments of the subject disclosure. In a very basic configuration 1202, computing device 1200 typically includes one or more processors 1204 and a system memory 1206. A memory bus 1208 may be used for communicating between processor 1204 and system memory 1206.

Depending on the desired configuration, processor 1204 may be of any type including but not limited to a microprocessor (μP), a microcontroller (μC), a digital signal processor (DSP), or any combination thereof. Processor 1204 may include one more levels of caching, such as a level one cache 1210 and a level two cache 1212, a processor core 1214, and registers 1216. An example processor core 1214 may include an arithmetic logic unit (ALU), a floating point unit (FPU), a digital signal processing core (DSP Core), or any combination thereof. An example memory controller 1218 may also be used with processor 1204, or in some implementations memory controller 1218 may be an internal part of processor 1204.

Depending on the desired configuration, system memory 1206 may be of any type including but not limited to volatile memory (such as RAM), non-volatile memory (such as ROM, flash memory, etc.) or any combination thereof. System memory 1206 may include an operating system 1220, one or more applications 1222, and program data 1224. Application 1222 can include components that are arranged to perform the functions as described herein. In some embodiments, application 1222 may be arranged to operate with program data 1224 on operating system 1220.

Computing device 1200 may have additional features or functionality, and additional interfaces to facilitate communications between basic configuration 1202 and any required devices and interfaces. For example, a bus/interface controller 1230 may be used to facilitate communications between basic configuration 1202 and one or more data storage devices 1232 via a storage interface bus 1234. Data storage devices 1232 may be removable storage devices 1236, non-removable storage devices 1238, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1206, removable storage devices 1236 and non-removable storage devices 1238 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 1200. Any such computer storage media may be part of computing device 1200.

Computing device 1200 may also include an interface bus 1240 for facilitating communication from various interface devices (e.g., output devices 1242, peripheral interfaces 1244, and communication devices 1246) to basic configuration 1202 via bus/interface controller 1230. Example output devices 1242 include a graphics processing unit 1248 and an audio processing unit 1250, which may be configured to communicate to various external devices such as a display or speakers via one or more A/V ports 1252. Example peripheral interfaces 1244 include a serial interface controller 1254 or a parallel interface controller 1256, which may be configured to communicate with external devices such as input devices (e.g., keyboard, mouse, pen, voice input device, touch input device, etc.) or other peripheral devices (e.g., printer, scanner, etc.) via one or more I/O ports 1258. An example communication device 1246 includes a network controller 1260, which may be arranged to facilitate communications with one or more other computing devices 1262 over a network communication link via one or more communication ports 1264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1200 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1200 may also be implemented as a personal computer including both laptop computer and non-laptop computer configurations.

### Example Networking Environment

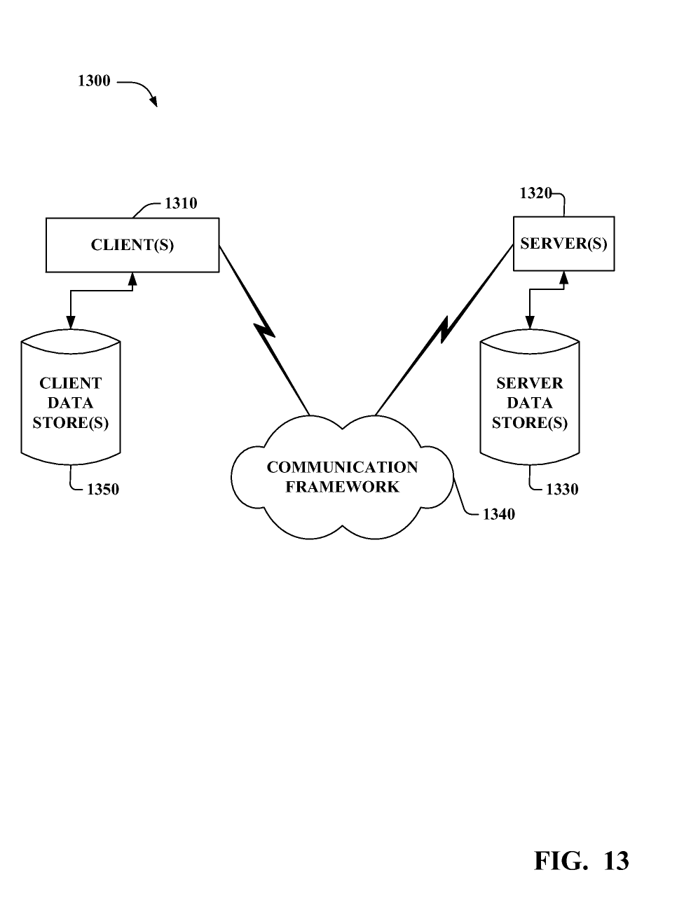

Turning now to FIG. 13 a block diagram illustrating an example networking environment that can be employed in accordance with the claimed subject matter is shown. The system 1300 includes one or more client(s) 1310. The client(s) 1310 can be hardware and/or software (e.g., threads, processes, computing devices). The system 1300 also includes one or more server(s) 1320. The server(s) 1320 can be hardware and/or software (e.g., threads, processes, computing devices). The servers 1320 can house threads to perform transformations by employing the subject innovation, for example.

One possible communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the servers 1320.

The subject disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The subject disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the subject disclosure have been described herein for purposes of illustration, and that various modifications may be made without departing from the scope and spirit of the subject disclosure. Accordingly, the various embodiments disclosed herein are not intended to be limiting, with the true scope and spirit being indicated by the following claims.

What is claimed is:

1. A system, comprising:
a memory storing computer-executable components; and
a processor, communicatively coupled to the memory, which executes or facilitates execution of one or more of the computer-executable components, the computer-executable components comprising:
a detection component configured to detect a request to initiate a multimedia application registered with a network service;
a playback component configured to initiate execution of the multimedia application on a first device in response to detection of the request by the detection component; and
a transfer component configured to transfer output of the multimedia application to a second device.

2. The system of claim 1, wherein the computer-executable components further comprise:
an authentication component configured to provide identification information to the network service, wherein the identification information includes login information and location information.

3. The system of claim 1, wherein the computer-executable components further comprise:
a quality of service component configured to transmit quality of service information to the network service.

4. The system of claim 3, wherein the quality of service component is further configured to block a process unrelated to execution and transfer of the multimedia application.

5. The system of claim 3, wherein the quality of service component is further configured to alter a quality of the output to maintain a quality of service level.

6. The system of claim 1, wherein the computer-executable components further comprise:
a registration component configured to register the multimedia application with the network service and transmit an availability time of the multimedia application.

7. The system of claim 1, wherein the multimedia application is a game, and the computer-executable components further comprise:
a display component configured to display information, wherein the information includes live game activity information, game history information, and credit information.

8. The system of claim 1, wherein the transfer component is further configured to receive feedback data from the second device, forward the feedback data to the playback component, and transfer output of the multimedia application to the second device.

9. A method, comprising:
detecting, by a system including at least one processor, a request to initiate a multimedia application registered with an online service from a first device associated with the online service;
initiating, by the system, execution of the multimedia application on a second device in response to the detecting the request; and
facilitating transferring, by the system, an output of the multimedia application from the second device to the first device.

10. The method of claim 9, further comprising authenticating, by the system, with the online service including providing identification information to the online service.

11. The method of claim 9, further comprising:
monitoring, by the system, quality of service information; and
transmitting, by the system, the quality of service information to the online service.

12. The method of claim 11, further comprising preventing, by the system, execution of a process unrelated to the execution of the multimedia application in response to a quality of service level satisfying a predetermined criterion.

13. The method of claim 9, further comprising:
registering, by the system, the multimedia application with the online service including indicating a time of availability of the multimedia application.

14. The method of claim 9, further comprising:
displaying, by the system, information about the multimedia application, including displaying live activity information relating to the multimedia application, history information relating to the multimedia application, and credit information relating to the multimedia application.

15. The method of claim 9, wherein the transferring the execution of the multimedia application further comprises:
receiving feedback from the first device; and
outputting a result of processing the feedback to the first device.

16-36. (canceled)

37. A computer-readable storage device comprising computer-executable instructions that, in response to execution, cause a system comprising a processor to perform operations, comprising:
initiating execution of a multimedia application on a first device in response to receiving a request to initiate execution of the multimedia application, wherein the multimedia application is registered with a network service;
transferring an output of the execution of the multimedia application from the first device to a second device; and
modulating the execution of the multimedia application on the first device based on feedback received from the second device.

38. The computer-readable storage device of claim 37, wherein the operations further comprise:
outputting a result of the modulating the execution of the multimedia application to the second device.

39. The computer-readable storage device of claim 37, wherein the operations further comprise:
transmitting identification information to the network service, wherein the identification information includes login information and location information; and
receiving an authentication notification in response to the transmitting the identification information.

40. The computer-readable storage device of claim 37, wherein the operations further comprise:
monitoring quality of service information associated with the first device; and
transmitting the quality of service information to the network service.

41. The computer-readable storage device of claim 40, wherein the operations further comprise:
blocking execution of a process on the first device unrelated to the execution of the multimedia application in response to a quality of service level being determined to satisfy a criterion.
